(19) United States
(12) Patent Application Publication
(10) Pub. No.: US 2013/0080148 A1
(43) Pub. Date: Mar. 28, 2013

(54) INFORMATION PROCESSING APPARATUS, INFORMATION PROCESSING METHOD, AND COMPUTER READABLE MEDIUM

(71) Applicant: Shaoming LIU, Kanagawa (JP)

(72) Inventor: Shaoming LIU, Kanagawa (JP)

(73) Assignee: FUJI XEROX Co., Ltd., Tokyo (JP)

(21) Appl. No.: 13/366,040

(22) Filed: Feb. 3, 2012

(30) Foreign Application Priority Data
Sep. 26, 2011 (JP) 2011-209938

(51) Int. Cl. G06F 17/20

(52) U.S. Cl. 704/8

(57) ABSTRACT

An information processing apparatus includes a text acquisition unit, a position correspondence information acquisition unit, first and second sub-text generation units, first and second comparison units, and a translated text determination unit. The text acquisition unit acquires a first text in a first language and a second text in a second language having the same content as the first text. The position correspondence information acquisition unit acquires, for each phrase, position correspondence information between a position of a word in the first language and a position of a corresponding word in the second language. The first sub-text generation unit divides the first text into plural first sub-texts, and the second sub-text generation unit divides the second text into plural second sub-texts. The translated text determination unit determines a translated text of at least one of the plural first sub-texts, which is one of the plural second sub-texts.

### CROSS-REFERENCE TO RELATED APPLICATIONS

This application is based on and claims priority under 35 USC 119 from Japanese Patent Application No. 2011-209938 filed Sep. 26, 2011.

### BACKGROUND

### (i) Technical Field

The present invention relates to an information processing apparatus, an information processing method, and a computer readable medium.

### SUMMARY

According to an aspect of the invention, there is provided an information processing apparatus including a text acquisition unit, a position correspondence information acquisition unit, a first sub-text generation unit, a second sub-text generation unit, a first comparison unit, a second comparison unit, and a translated text determination unit. The text acquisition unit acquires a first text written in a first language and a second text having the same content as the first text and written in a second language, the second text. The position correspondence information acquisition unit acquires, for each of phrases in plural formats, position correspondence information indicating a correspondence relationship between a position of a given word in the phrase when the phrase is written in the first language and a position of a word corresponding to the given word in the phrase when the phrase is written in the second language. The first sub-text generation unit divides the first text into plural first sub-texts. The second sub-text generation unit divides the second text into plural second sub-texts. The first comparison unit compares, for each of the phrases in the plural formats, a layout of plural words in the phrase when the phrase is written in the first language with a layout of the plural first sub-texts in the first text. The second comparison unit compares, for each of the phrases in the plural formats, a layout of plural words in the phrase when the phrase is written in the second language and a layout of the plural second sub-texts in the second text. The translated text determination unit determines a translated text of at least one of the plural first sub-texts, the translated text being one of the plural second sub-texts which is obtained by translating the at least one of the plural first sub-texts into the second language, in accordance with a comparison result obtained by the first comparison unit, a comparison result obtained by the second comparison unit, and the position correspondence information.

### BRIEF DESCRIPTION OF THE DRAWINGS

Exemplary embodiment(s) of the present invention will be described in detail based on the following figures, wherein:

FIG. 1 illustrates the configuration of an information processing apparatus according to an exemplary embodiment of the present invention;

FIG. 2 illustrates an example of data stored in a bilingual example sentence dictionary database;

FIG. 3 illustrates an example of data stored in a bilingual sentence pattern dictionary database;

FIG. 4 illustrates a data structure of one sentence pattern;

FIG. 5 illustrates an example of a bilingual sentence pattern;

FIG. 6 illustrates an example of data stored in a bilingual phrase dictionary database;

FIG. 7 illustrates an example of data stored in a bilingual word dictionary database;

FIG. 8 illustrates a process flow of a sentence pattern matching unit according to the exemplary embodiment;

FIG. 9 illustrates a process flow of a distance calculation unit according to the exemplary embodiment;

FIG. 10 illustrates an example of a calculation process of the distance calculation unit according to the exemplary embodiment;

FIG. 11 illustrates a process flow of a mapping extraction unit according to the exemplary embodiment;

FIG. 12 illustrates a process flow of the mapping extraction unit according to the exemplary embodiment;

FIG. 13 illustrates a process flow of the mapping extraction unit according to the exemplary embodiment;

FIG. 14 is a flowchart illustrating the operation of the information processing apparatus according to the exemplary embodiment;

FIG. 15 is a flowchart illustrating text processing performed by the information processing apparatus according to the exemplary embodiment;

FIG. 16 is a flowchart illustrating phrase processing performed by the information processing apparatus according to the exemplary embodiment;

FIG. 17 is a flowchart illustrating a translated text determination process and a registration process, which are performed by the information processing apparatus according to the exemplary embodiment;

FIG. 18 illustrates an example of data to be processed by the information processing apparatus according to the exemplary embodiment;

FIG. 19 illustrates an example of data to be processed by the information processing apparatus according to the exemplary embodiment;

FIG. 20 illustrates an example of data to be processed by the information processing apparatus according to the exemplary embodiment; and

FIG. 21 illustrates an example of data to be processed by the information processing apparatus according to the exemplary embodiment.

### DETAILED DESCRIPTION

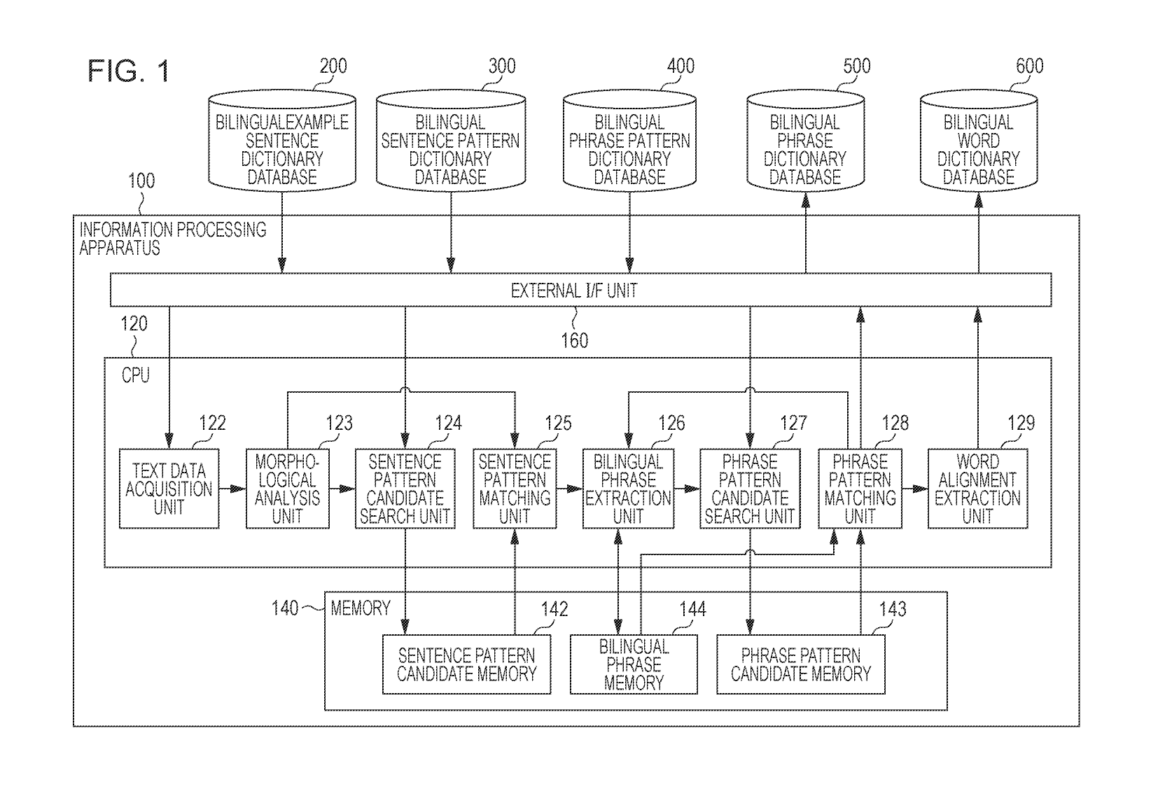

An exemplary embodiment of the present invention will be described in detail hereinafter with reference to the drawings. FIG. 1 illustrates the configuration of an information processing apparatus 100 according to an exemplary embodiment of the present invention. The information processing apparatus 100 is connected to a bilingual example sentence dictionary database 200, a bilingual sentence pattern dictionary database 300, a bilingual phrase pattern dictionary database 400, a bilingual phrase dictionary database 500, and a bilingual word dictionary database 600. The information processing apparatus 100 includes a central processing unit (CPU) 120, a memory 140, and an external interface (I/F) unit 160.

The CPU 120 of the information processing apparatus 100 is operated in accordance with a program stored in the memory 140. The details of the CPU 120 will be described below.

The memory 140 of the information processing apparatus 100 may be a storage element, and stores a program to be read by the CPU 120 and various kinds of data generated through processes performed by respective units in the CPU 120, which will be described below. The memory 140 includes a program memory 141 (not illustrated) that stores the program described above, and memories that store the various kinds of data described above, namely, a sentence pattern candidate memory 142, a phrase pattern candidate memory 143, and a bilingual phrase memory 144. The sentence pattern candidate memory 142, the phrase pattern candidate memory 143, and the bilingual phrase memory 144 will be described below.

The external I/F unit 160 of the information processing apparatus 100 controls exchange of data between the CPU 120 and each of the databases connected to the information processing apparatus 100, namely, the bilingual example sentence dictionary database 200, the bilingual sentence pattern dictionary database 300, the bilingual phrase pattern dictionary database 400, the bilingual phrase dictionary database 500, and the bilingual word dictionary database 600 (hereinafter collectively referred to as the “individual databases”). The external I/F unit 160 outputs data input from the CPU 120 to the individual databases. The external I/F unit 160 further acquires data from the individual databases in accordance with a control signal input from the CPU 120, and outputs the data to the CPU 120.

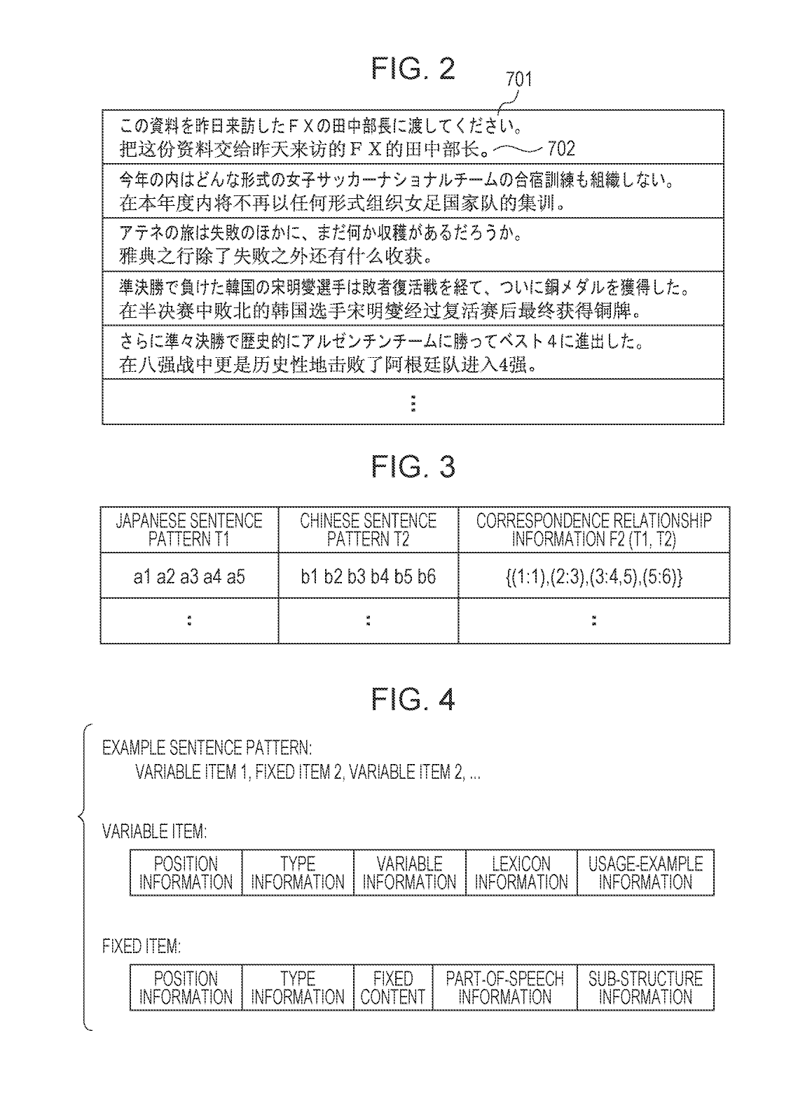

The bilingual example sentence dictionary database 200 stores bilingual example dictionary data in languages between which a text to be translated is determined by the information processing apparatus 100. For example, when a text to be translated between Japanese (first language) and Chinese (second language) is determined, an example sentence (text) in Japanese and a corresponding example sentence (text) in Chinese are stored in association with each other. The data stored here may be acquired from a certain database, or may be input from the user of the information processing apparatus 100 or the like and may be stored. FIG. 2 illustrates example of data stored in the bilingual example sentence dictionary database 200.

The bilingual sentence pattern dictionary database 300 stores bilingual sentence pattern dictionary data in languages between which a text to be translated is determined by the information processing apparatus 100. FIG. 3 illustrates example of data stored in the bilingual sentence pattern dictionary database 300. The bilingual sentence pattern dictionary data may be position correspondence information indicating, for each of elements in plural formats (fixed item or variable item), the correspondence relationship between the position of a given word/variable item when the element is written in the first language and the position of the given word/word corresponding to variable item/variable item when the element is written in the second language. For example, a sentence pattern T1 (first layout information) obtained when a phrase in a given format is written in the first language, i.e., Japanese, is represented by a1a2a3a4a5, and a sentence pattern T2 (second layout information) obtained when the phrase in the given format is written in the second language, i.e., Chinese, is represented by b1b2b3b4b5b6, where ax and bx are elements of a sentence pattern, i.e., fixed items or variable items). It is assumed that a1 corresponds to b1, a2 corresponds to b3, a3 corresponds to b4 and b5, and a5 corresponds to b6. In this case, correspondence relationship information F2(T1, T2) may be represented by F2(T1, T2)={(1:1), (2:3), (3:4, 5), (5:6)}.

FIG. 4 illustrates the data structure of one sentence pattern. The sentence pattern may be information indicating the constructs of a sentence in a given language, and includes a fixed item representing a fixed character string in the sentence and a variable item representing a variable character string in the sentence. The term “character string” is used to refer to a word or a phrase having plural words. One sentence pattern includes one or plural fixed items and one or plural variable items. In FIG. 4, fixed items and variable items are arranged in order, starting from the item to be located at the beginning of a sentence.

Each variable item includes position information, type information, variable information, lexicon information, and usage-example information. Each fixed item includes position information, type information, fixed content, part-of-speech information, and sub-structure information. The position information is included in both the fixed item and the variable item, and may represent a sequential number that defines the order in which the corresponding item appears in the sentence. The type information is information indicating the item type, i.e., variable item or fixed item, and is represented as “f” for the fixed item and “v” for the variable item. The variable information is information indicating the part of speech of the variable item. For example, “NP” represents a variable of a noun phrase, “AP” represents a variable of an adjective phrase, and “DP” represents a variable of an adverb phrase. The lexicon is information indicating a lexicon which specifies what category a fundamental word included in the variable item (or a word that affects the meaning of a phrase) can have. The usage-example information is information indicating usage examples of a fundamental word included in a variable item in a sentence pattern. The fixed content is information indicating a character string of the fixed item, and the part-of-speech information is information indicating the part of speech of a word set as the fixed item. For example, if a Japanese word has part-of-speech information “61”, the fixed item represents a Japanese particle. The sub-structure information indicates information about each of plural words making up the fixed item.

Here, information indicating the presence of a variable item and information about the fixed content of a fixed item, which may be characteristic in a sentence pattern, are referred to as “language construct information”. Specifically, the language construct information corresponds to the position information and type information in a variable item and the position information, type information, and fixed content in a fixed item. In the following description, language construct information included in an example sentence pattern in the source language is referred to as “source-language construct information”, and language construct information included in an example sentence pattern in the target language is referred to as “target-language construct information”.

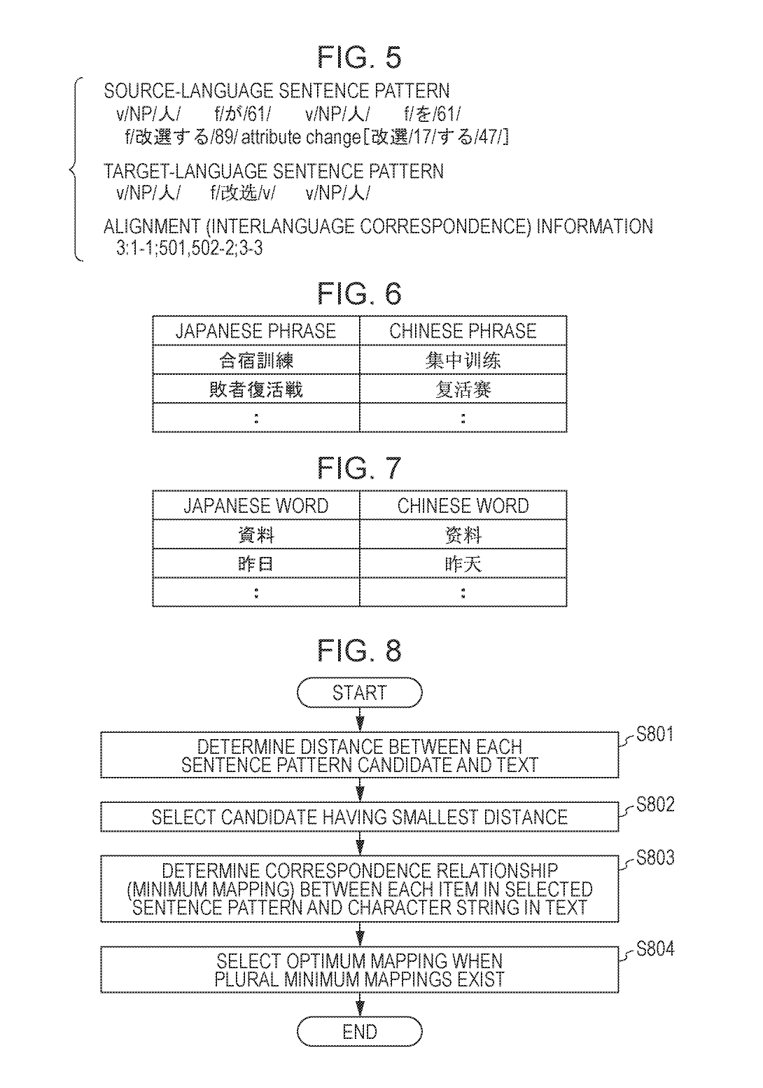

FIG. 5 illustrates an example of a bilingual sentence pattern. The bilingual sentence pattern includes a source-language (first-language) sentence pattern, a target-language (second-language) sentence pattern, and alignment information. In the sentence pattern illustrated in FIG. 5, a delimiter between a fixed item and a variable item is a space, and a delimiter between pieces of information included in a fixed item and a variable item is a forward slash “/”. In FIG. 5, furthermore, position information is represented by the order in which fixed items and variable items are arranged, instead of using any mark in an individual variable item or fixed item. For example, “v/NP/ [symbol] /”, which is the first item in the source-language sentence pattern, indicates a variable item, a noun phrase, a lexicon of “ [symbol] ”, and no usage examples being set. The fifth item in the source-language sentence pattern, “f/ [symbol] /89/attribute change[ [symbol] /17/ [symbol] /47/]”, indicates a fixed item, a character string “ [symbol] ”, which is a verb (89) with an irregular conjunction named sa-gyo henkaku katsuyo or a sa-row irregular conjunction, which is one of Japanese verb conjunctions. The fifth item “f/ [symbol] /89/attribute change[ [symbol] /17/ [symbol] /47/]” further indicates that the character string “ [symbol] ” is composed of sub-structures “ [symbol] (kaisen (re-election))” and “ [symbol] (suru (to do))”, in which an attribute change occurs.

The alignment information may be interlanguage correspondence information including correspondence relationships between variable items in the source language and variable items in the target language and correspondence relationships between fixed items in the source language and fixed items in the target language. In FIG. 5, “3:” indicates that three associations are present, “1-1;” indicates that the first item in the source-language sentence pattern corresponds to the first item in the target-language sentence pattern, and “501,502-2;” indicates that the first and second sub-items of the fifth item in the source-language sentence pattern correspond to the second item in the target-language sentence pattern. Here, “501” indicates first sub-item of the fifth item in the source-language sentence pattern.

The bilingual phrase pattern dictionary database 400 stores bilingual phrase pattern dictionary data in languages between which a text to be translated is determined by the information processing apparatus 100. The bilingual phrase pattern dictionary database 400 stores data having a format similar to that illustrated in FIG. 3.

The bilingual phrase dictionary database 500 stores bilingual phrase data for which a text to be translated has been determined by the information processing apparatus 100. FIG. 6 illustrates example of data stored in the bilingual phrase dictionary database 500.

The bilingual word dictionary database 600 stores bilingual word data for which a text to be translated has been determined by the information processing apparatus 100. FIG. 7 illustrates example of data stored in the bilingual word dictionary database 600.

The CPU 120 of the information processing apparatus 100 will now be described in detail. The CPU 120 includes a controller 121 (not illustrated), a text data acquisition unit 122, a morphological analysis unit 123, a sentence pattern candidate search unit 124, a sentence pattern matching unit 125, a bilingual phrase extraction unit 126, a phrase pattern candidate search unit 127, a phrase pattern matching unit 128, and a word alignment extraction unit 129.

The operation of the respective units in the CPU 120 will be described using an example of data to be actually processed. In the following, a description will be given of a case where processing is performed on text data 701 and text data 702 which are stored in the bilingual example sentence dictionary database 200 illustrated in FIG. 2.

The controller 121 controls the overall operation of the CPU 120. The text data acquisition unit 122 operates as a text acquisition unit that acquires text data (first text) written in a first language and text data (second text) having the same content as the first text and written in a second language. The text data acquisition unit 122 acquires the text data 701 written in the first language and the text data 702 written in the second language from the bilingual example sentence dictionary database 200, and outputs the text data 701 and the text data 702 to the morphological analysis unit 123.

The morphological analysis unit 123 operates as a first sub-text generation unit that divides the first text into plural first sub-texts (morphemes or words) and that assigns an appropriate part of speech to each of the obtained morphemes or words and also operates as a second sub-text generation unit that divides the second text into plural second sub-texts (morphemes or words) and that assigns an appropriate part of speech to each of the obtained morphemes or words. The morphological analysis unit 123 performs morphological analysis of the text data 701 and the text data 702 which have been input from the text data acquisition unit 122. Specifically, the morphological analysis unit 123 performs morphological analysis, namely, dividing each of the text data 701 and the text data 702 which have been input from the text data acquisition unit 122 into morphemes or words (first sub-texts, second sub-texts) and assigning an appropriate part of speech to each of the morphemes or words. The morphological analysis may be based on an existing morphological analysis technique, for example, “Chasen”, which is a morphological analysis technique of Japan, or is a morphological analysis technique of China, e.g., Seg & POC tool of Tsinghua University or CiPosSDK tool of Northeastern University, China.

The sentence pattern candidate search unit 124 operates as a position correspondence information acquisition unit that acquires, for each of phrases in plural formats, position correspondence information indicating a correspondence relationship between the position of a given word in the phrase when the phrase is written in the first language and the position of a corresponding word in the phrase when the phrase is written in the second language. The sentence pattern candidate search unit 124 also operates as a layout information acquisition unit that acquires, for each of the phrases in the plural formats, first layout information indicating a layout of plural words in the phrase when the phrase is written in the first language and second layout information indicating a layout of correspondence plural words in the phrase when the phrase is written in the second language. The sentence pattern candidate search unit 124 acquires, as sentence pattern candidate, a sentence pattern (a set of first and second sentence patterns) that can match the first text and the second text from the bilingual sentence pattern dictionary data stored in the bilingual sentence pattern dictionary database 300. A sentence pattern candidate may be searched for by using an existing search method, for example, the method disclosed in Japanese Unexamined Patent Application Publication No. 2009-129032. A sentence pattern candidate extracted as a result of search is stored in the sentence pattern candidate memory 142 of the memory 140.

The sentence pattern matching unit 125 operates as a first matching unit (first comparison unit) that matches the layout of the items in the first sentence pattern against the layout of the plural first sub-texts in the first text, and also operates as a second matching unit (second comparison unit) that matches the layout of the items in the second sentence pattern against the layout of the plural second sub-texts in the second text. The sentence pattern matching unit 125 also operates as a layout information determination unit that determines an item among the items in the first sentence pattern which corresponds to each of the sub-texts in the first text and an item among the items in the second sentence pattern which corresponds to each of the sub-texts in the second text in accordance with the matching result obtained by the first matching unit, the matching result obtained by the second matching unit, and information about the correspondences between the items in the first sentence pattern and the items in the second sentence pattern. The sentence pattern matching unit 125 performs a pattern matching process of matching the first text and the second text which have been subjected to morphological analysis against the first sentence pattern and the second sentence pattern in the sentence pattern candidate stored in the sentence pattern candidate memory 142, respectively, and determines whether or not the bilingual text can match the bilingual sentence pattern candidate. The pattern matching process may be performed by using a method described below, and computes an “extended editing distance” indicating an amount of editing required to change the first text (or second text) to the format suitable for the first sentence pattern (or second sentence pattern).

The pattern matching process will now be described. FIG. 8 illustrates a process flow of the sentence pattern matching unit 125 according to this exemplary embodiment. First, a distance calculation unit 130 (not illustrated) included in the sentence pattern matching unit 125 determines a distance between each first sentence pattern (or second sentence pattern) candidate and the first text (or second text) (step S801). In the following, a description will be given of the process of step S801 with reference to a flow of the process performed by the distance calculation unit 130.

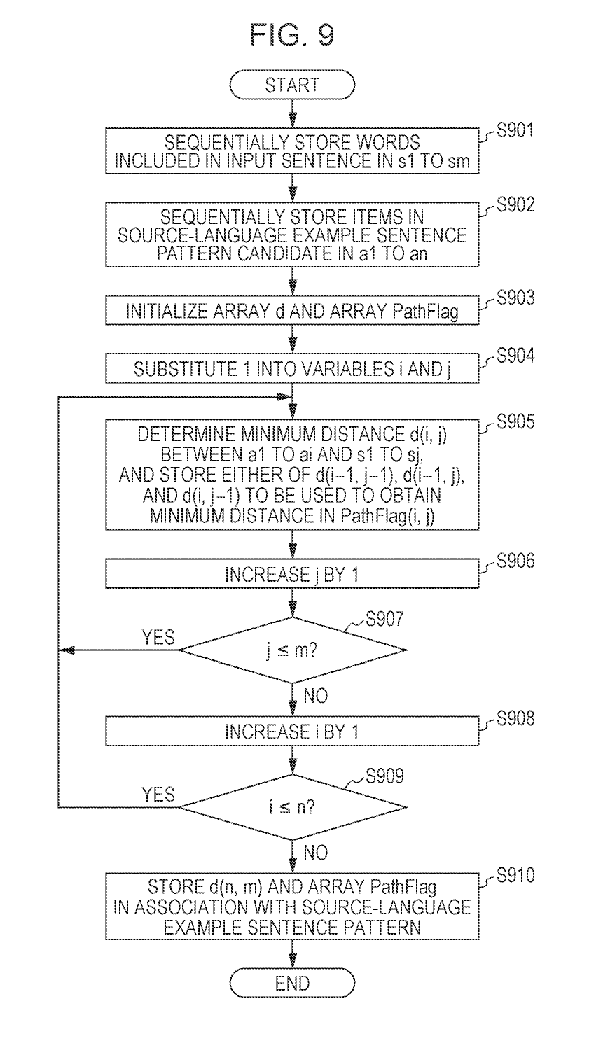

FIG. 9 illustrates an exemplary process flow of the distance calculation unit 130 according to this exemplary embodiment. In FIG. 9, only a process flow of calculating an extended editing distance between the first text (or second text) and one first sentence pattern (or second sentence pattern) candidate. In actuality, the illustrated process is repeated a number of times corresponding to the number of first sentence pattern (or second sentence pattern) candidates. First, the distance calculation unit 130 sequentially stores words (the number of which is presented by m) into which an input sentence has been divided by the morphological analysis unit 123, in data strings s1 to sm (step S901). Then, the distance calculation unit 130 obtains, for each of variable items and fixed items (the total number of which is represented by n) in one first sentence pattern candidate, information indicating whether or not the item is a variable item and information about a character string of fixed content when the item is a fixed item, and sequentially stores the obtained pieces of information in data strings a1 to an in order from the smallest value of the position information (step S902). In the following description, s0 and a0 represent the beginnings of the first text and the first sentence pattern, respectively, and correspond to null character strings.

The extended editing distance between the first text and the first sentence pattern may depend on the correspondence relationship between the individual words in the first text and variable items and fixed items in the first sentence pattern. The extended editing distance between the first text and the first sentence pattern may be determined by determining a conversion weight for each of plural correspondence relationships between the first text and the first sentence pattern and by setting the smallest conversion weight among the determined conversion weights as the distance. A conversion weight for a certain correspondence relationship may be determined by integrating a weight between each of variable items and fixed items and a corresponding word and a weight between a word and an item when the word and the item do not correspond to each other. More specifically, for example, if ai (where i is 1 to n) corresponds to sj (where j is 1 to m), ai can correspond to an arbitrary sub-text when ai is a variable item. There, the editing weight is 0. When ai is a fixed item, if ai and sj represent the same word, the editing weight is 0 because no editing may be required. If ai and sj represent different words, the editing weight is p because substitution may be required. If sj corresponding to ai does not exist, the editing weight is q because the insertion of a word to the input sentence may be required. Conversely, if ai corresponding to sj does not exist, the editing weight is r because the deletion of a word from the input sentence may be required. Resulting weights are integrated. Here, p, q, and r are positive constants. The correspondence relationships may satisfy the condition that the words in the first sentence pattern are not reordered or the words in the first text are not reordered and the condition that a variable item might correspond to plural words in the input sentence. The former condition is that, for example, if ai and sj correspond to each other, a(i+1) and s(j−1) do not correspond to each other. The latter condition is generated because a variable item may be a phrase including plural words. From the former condition, the minimum distance d(i, j) within all the correspondence relationships between a1 to ai in the first sentence pattern and s1 to sj in the input sentence may be determined if all of d(i−1, j−1), d(i−1, j), and d(i, j−1) and the relationship between ai and sj are obtained. In the following, a description will be given of a calculation method using the above rules.

The distance calculation unit 130 initializes a two-dimensional (n+1)×(m+1) array d storing distance values, and an n×m array PathFlag indicating which of d(i−1, j−1), d(i−1, j), and d(i, j−1) is to be used to obtain the minimum distance d(i, j) (step S903). The array d has d(0, 0) to d(n, m), and d(i, j) denotes the distance between the character string segments a1, a2, . . . , ai and s1, s2, . . . , sj. i×q is substituted into d(i, 0), and j×r is substituted into d(0, j). The array PathFlag has PathFlag(1, 1) to PathFlag(n, m). Next, 1 is substituted into the variables i and j (step S904), and iterative processing is initiated. The distance calculation unit 130 determines the minimum distance d(i, j) between a1 to ai and s1 to sj, and stores either of d(i−1, j−1), d(i−1, j), and d(i, j−1) to be used to obtain the minimum distance d(i, j) in PathFlag(i, j) (step S905). d(i, j) may be calculated by the following method:

If ai is a variable item,

d(i, j)=min{d(i−1, j−1)+w(ai, sj), d(i−1, j)+q, d(i, j−1)}

If ai is a fixed item,

d(i, j)=min{d(i−1, j−1)+w(ai, sj), d(i−1, j)+q, d(i, j−1)+r}

In the above equations, for example, w(ai, sj) is 0 if ai is a variable item. For example, if ai is a fixed item, w(ai, sj) is 0 when ai and sj are equal, and is p when ai and sj are not equal. If plural minimum distances among d(i−1, j−1), d(i−1, j), and d(i, j−1) exist, information about all the minimum distances is stored in PathFlag(i, j).

Next, the distance calculation unit 130 increases j by (step S906). The distance calculation unit 130 compares j with m (step S907). If j is less than or equal to m in step S907, the process repeats from step S905. If j is not less than or equal to m, the distance calculation unit 130 increases i by 1 (step S908), and determines whether or not i is less than or equal to n (step S909). If i is less than or equal to n, the process repeats from step S905. If i is not less than or equal to n, the distance calculation unit 130 stores the distance variable d(n, m) and the array PathFlag in association with the first sentence pattern (step S910). Then, the process ends.

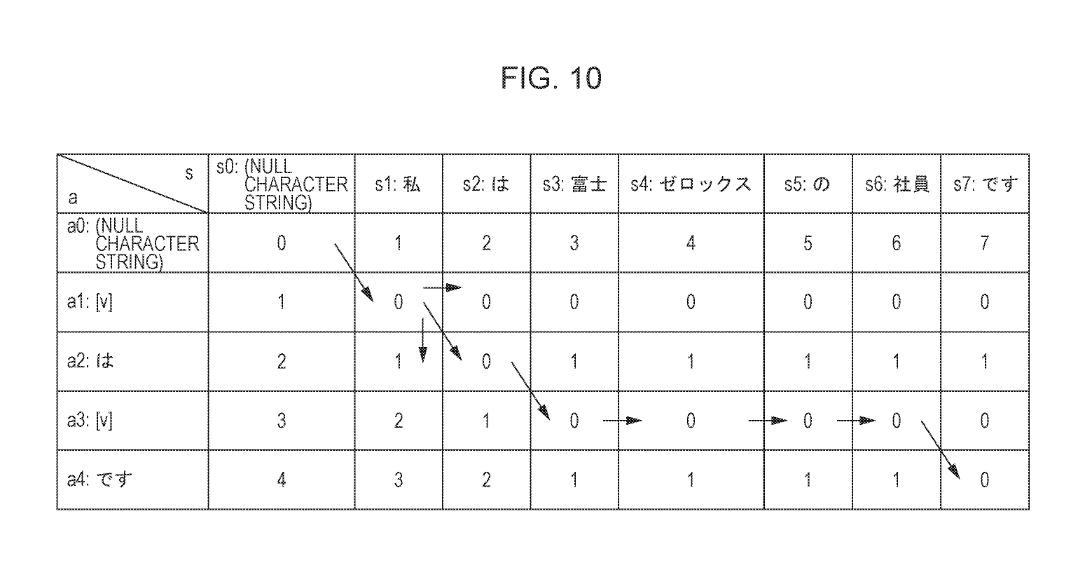

FIG. 10 illustrates an example of a calculation process of the distance calculation unit 130 according to this exemplary embodiment. In a table illustrated in FIG. 10, each cell has a value representing the value of a corresponding one of the cells of the array d, and arrows represent through which cells among cells from upper left to lower right, cells from left to right, and cells from up to down calculation is performed to obtain a minimum distance. In the illustrated example, by way of example, a minimum distance is calculated for an input sentence “ [symbol] [symbol] (which is a Japanese sentence that means I am an employee of Fuji Xerox)” and a source-language construct information candidate “[v] [symbol] [v] [symbol] (which is a Japanese sentence pattern that means [v] am/are/is [v])”. In the illustrated example, p=q=r=1. It may be seen from the illustrated table that the array PathFlag represents the relationship between words in the input sentence and each of the variable items and the fixed items when a minimum distance is calculated.

In FIG. 8, after the extended editing distance between the first text (or second text) and each of the first sentence pattern (or second sentence pattern) candidates is determined using the processing of step S801, the sentence pattern matching unit 125 selects a first sentence pattern (or second sentence pattern) with the minimum extended editing distance among the first sentence pattern (or second sentence pattern) candidates (step S802). The number of first sentence patterns (or second sentence patterns) to be selected here may not necessarily be one. Even though there is one type of first sentence pattern (or second sentence pattern) with a minimum distance, for example, if plural bilingual example sentence patterns having the same first sentence pattern (or second sentence pattern) exist, a number of first sentence patterns (or second sentence patterns) corresponding to the number of bilingual example sentence patterns may be selected.

Then, the sentence pattern matching unit 125 determines a correspondence relationship (hereinafter referred to as a “minimum mapping”) between each of fixed items and variable items of the selected first sentence pattern (or second sentence pattern) and a character string in the first text (or second text) (step S803). The processing of step S803 is performed by a mapping extraction unit 131 (not illustrated) included in the sentence pattern matching unit 125. The processing of step S803 will be described hereinafter with reference to a process flow of the mapping extraction unit 131.

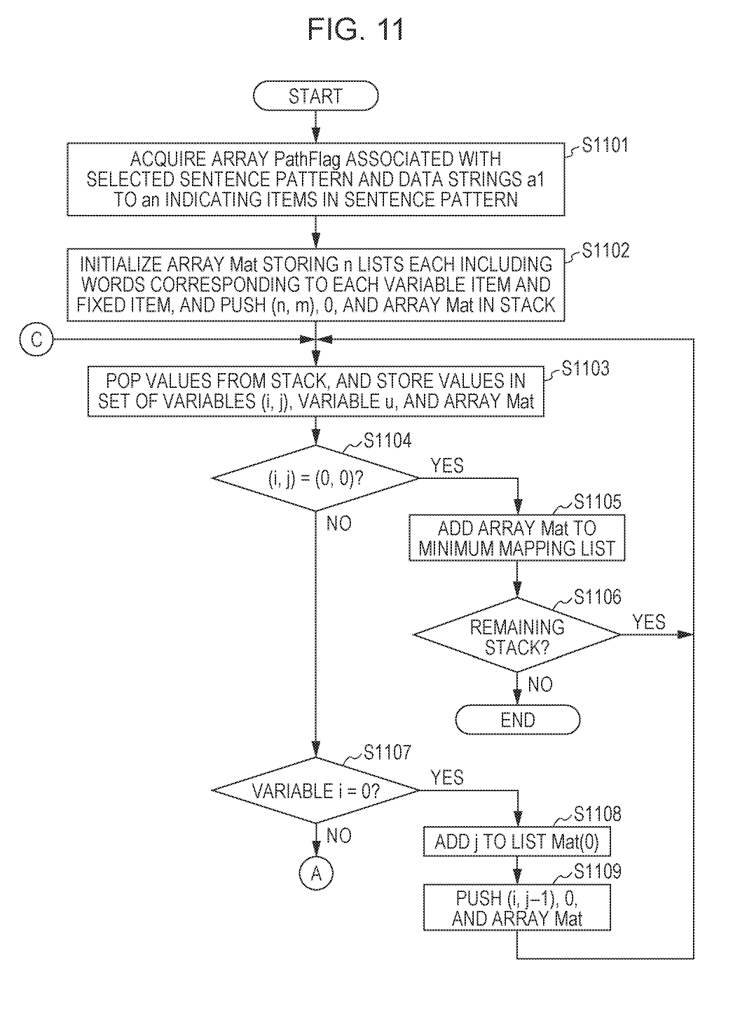

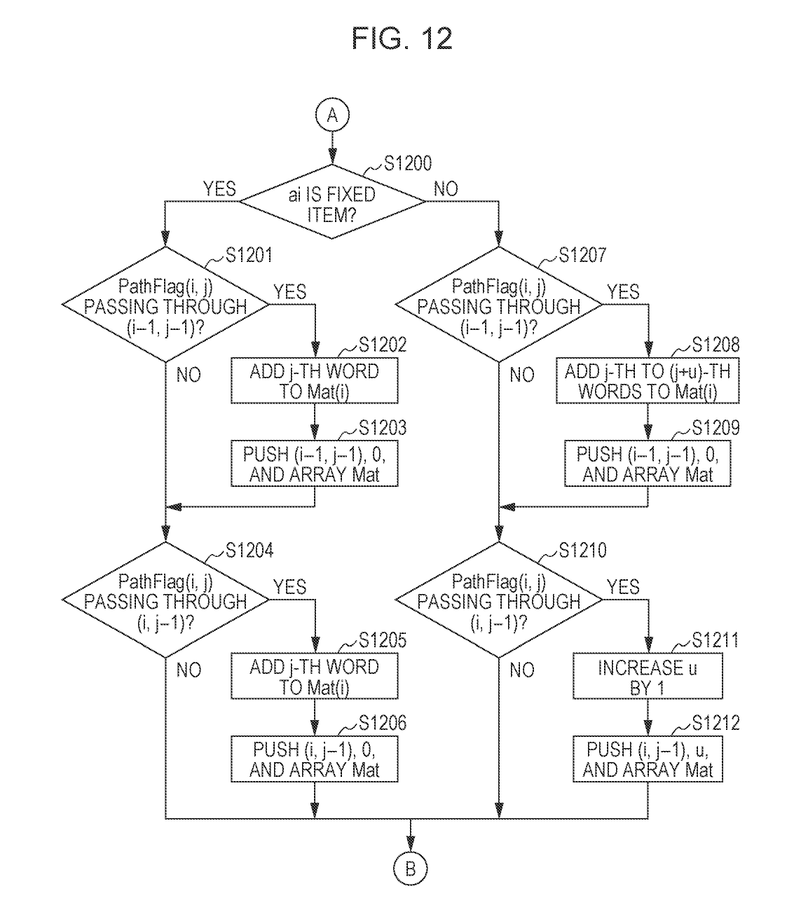

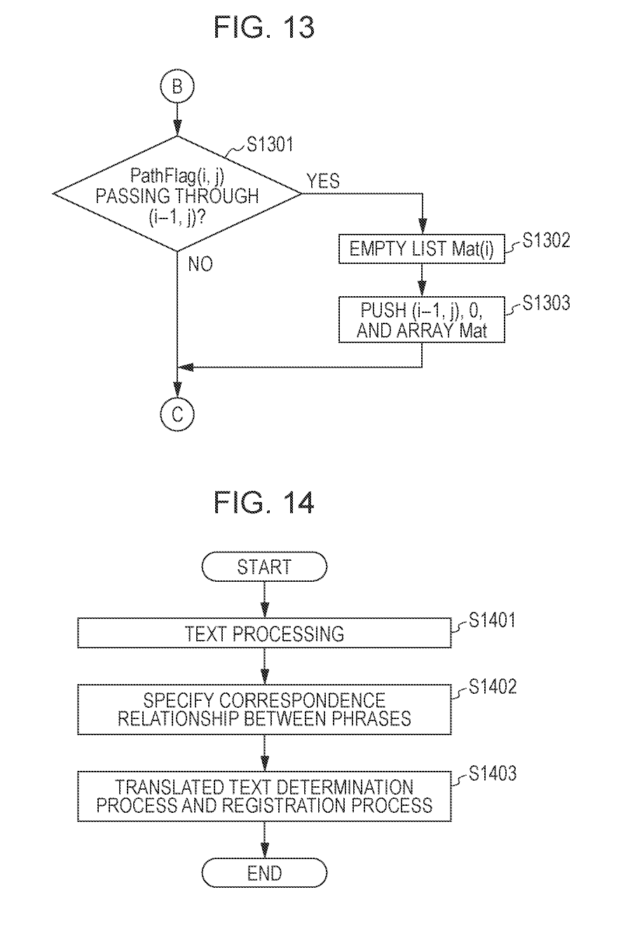

FIGS. 11 to 13 illustrate an exemplary process flow of the mapping extraction unit 131 according to this exemplary embodiment. First, the mapping extraction unit 131 acquires an array PathFlag stored in association with the selected first sentence pattern (or second sentence pattern), and also acquires data strings a1 to an in which information about variable items and fixed items included in the first sentence pattern (or second sentence pattern) is stored in order according to the values of the position information (step S1101). Specifically, the information about variable items and fixed items includes information as to whether or not the item is a variable item and information about a character string of fixed content when the item is a fixed item. Next, the mapping extraction unit 131 initializes an array Mat including n lists each storing one or plural words corresponding to each variable item and fixed item in the selected first sentence pattern (or second sentence pattern), and pushes (n, m), 0, and the array Mat into a stack (step S1102).

Next, the mapping extraction unit 131 pops the above values from the stack, and stores the values in a set of variables (i, j), a variable u, and the array Mat (step S1103). If the set of variables (i, j) is (0, 0) in step S1104, a minimum mapping has been determined, and therefore the array Mat is added to a minimum mapping list Fset (step S1105). If any stack remains in step S1106, the process repeats from step S1103. If no stack remains in step S1106, the process ends. If it is determined in step S1104 that the set of variables (i, j) is not (0, 0), it is determined whether or not the variable i is 0 (step S1107). If the variable i is 0, the j-th word in the input sentence is missing and therefore is added to the list Mat(0) (step S1108). The set of variables (i, j−1), 0, and the array Mat are pushed (step S1109). Then, the process repeats from step S1103.

If it is determined in step S1107 that the variable i is not 0, it is determined whether or not ai is a fixed item (step S1200). If ai is a fixed item, determination for the PathFlag(i, j) is performed (step S1201). If it is determined in step S1201 the PathFlag(i, j) indicates that d(i, j) has been determined from d(i−1, j−1), the j-th word is added to the list Mat(i) (step S1202), and the set of variables (i−1, j−1), 0, and the array Mat are pushed (step S1203). In the following, the PathFlag(i, j) indicating that d(i, j) has been determined from d(i−1, j−1) is referred to as “the PathFlag(i, j) passing through (i−1, j−1)”. Further, the PathFlag(i, j) indicating that d(i, j) has been determined from d(i, j−1) is hereinafter referred to as “the PathFlag(i, j) passing through (i, j−1)”, and the PathFlag(i, j) indicating that d(i, j) has been determined from d(i−1, j) is hereinafter referred to as “the PathFlag(i, j) passing through (i−1, j)”. If it is determined in step S1201 that the PathFlag(i, j) does not pass through (i−1, j−1) and after the processing of step S1203 is completed, it is determined whether or not the PathFlag(i, j) passes through (i, j−1) (step S1204). If the PathFlag(i, j) passes through (i, j−1), this means that the addition of a word may be required and therefore the j-th word is added to the list Mat(i) (step S1205), and the set of variables (i, j−1), 0, and the array Mat are pushed (step S1206). If the PathFlag(i, j) does not pass through (i, j−1) and after the processing of step S1206 is completed, the process proceeds to step S1301. If it is determined in step S1200 that ai is a variable item, it is determined whether or not the PathFlag(i, j) passes through (i−1, j−1) (step S1207). If the PathFlag(i, j) passes through (i−1, j−1), the j-th to (j+u)-th words are added to the list Mat(i) (step S1208), and the set of variables (i−1, j−1), 0, and the array Mat are pushed (step S1209). If it is determined in step S1207 that the PathFlag(i, j) does not pass through (i−1, j−1) and after the processing of step S1209 is completed, it is determined whether or not the PathFlag(i, j) passes through (i, j−1) (step S1210). If the PathFlag(i, j) passes through (i, j−1), u is increased by 1 (step S1211), and the set of variables (i, j−1), the variable u, and the array Mat are pushed (step S1212). If it is determined in step S1210 that the PathFlag(i, j) does not pass through (i, j−1) and after the processing of step S1212 is completed, the process proceeds to step S1301.

In step S1301, it is determined whether or not the PathFlag(i, j) passes through (i−1, j). If the PathFlag(i, j) passes through (i−1, j), this means that word missing has occurred. Thus, the list Mat(i) is emptied (step S1302), and the set of variables (i−1, j), 0, and the array Mat are pushed (step S1303). If it is determined in step S1301 that the PathFlag(i, j) does not pass through (i−1, j) and after the processing of step S1303 is completed, the process repeats from step S1103. With the above processes, a mapping list Fset is acquired. The use of a stack allows plural mappings to be obtained.

After a mapping has been obtained through the processing of step S803, the sentence pattern matching unit 125 checks whether or not plural mappings exist. If plural mappings exist, one of the mappings is selected (step S804). The processing of step S804 may be performed by an optimum mapping selection unit 132 (not illustrated) included in the sentence pattern matching unit 125. If plural mappings exist, the optimum mapping selection unit 132 evaluates, for each mapping, a phrase including words that are variable items in accordance with some standards, and selects one mapping on the basis of the total assessment of the obtained evaluations. Examples of the standards for evaluation include whether or not the phrase is found in a dictionary, and whether or not the phrase includes a verb, a particle, or an auxiliary verb.

A target-language construct information selection unit 133 (not illustrated) included in the sentence pattern matching unit 125 selects one second sentence pattern, based on evaluation information associated with first sentence patterns and second sentence patterns, from among plural second sentence patterns that define the constructs of a sentence in the target language corresponding to the selected first sentence pattern. Each of the plural second sentence patterns includes a fixed character string representing a fixed item in the sentence and a variable character string representing a variable item in the sentence. The “evaluation information” is used to refer to a portion of a bilingual example sentence pattern, from which the portion corresponding to the first sentence pattern is excluded. A bilingual example sentence pattern includes a first sentence pattern and a second sentence pattern, and is therefore associated with the first sentence pattern and the second sentence pattern. Further, the variable information (part-of-speech information), lexicon, and usage-example information in a variable item in the first sentence pattern, and the interlanguage correspondence information, bilingual example sentence information, etc., in the bilingual example sentence pattern are also associated with the first sentence pattern. The variable information (part-of-speech information), lexicon, and usage-example information in a variable item are information indicating the attributes of the variable item. Selecting a second sentence pattern may be substantially equivalent to also selecting an example sentence pattern in the target language and selecting a bilingual example sentence pattern.

If the extended editing distance between the first text and the first sentence pattern and the extended editing distance between the second text and the second sentence pattern are “0”, the sentence pattern matching unit 125 determines that the pattern candidates can match the input bilingual text sentence. Information about matching between the first text and the first sentence pattern and information about matching between the second text and the second sentence pattern, which have been obtained by the sentence pattern matching unit 125, are output to the bilingual phrase extraction unit 126.

After the sentence pattern matching unit 125 or the phrase pattern matching unit 128 has determined a first pattern and a second pattern, the bilingual phrase extraction unit 126 acquires a first sub-text as a first text and further divides the first text into segments. The bilingual phrase extraction unit 126 also acquires a second sub-text as a second text and further divides the second text into segments. Specifically, the bilingual phrase extraction unit 126 performs morphological analysis on each of phrases in text data that has been determined by the sentence pattern matching unit 125 to be a pattern defined by the sentence pattern candidate stored in the sentence pattern candidate memory 142 to divide the phrase into segments, and the obtained data segments are output to and stored in the bilingual phrase memory 144.

The phrase pattern candidate search unit 127 searches phrase patterns stored in the bilingual phrase pattern dictionary database 400 for a phrase pattern (phrase pattern candidate) that can match the phrase that has been subjected to morphological analysis by the bilingual phrase extraction unit 126 and that is stored in the bilingual phrase memory 144. As with the sentence pattern candidate search unit 124, a phrase pattern candidate may be searched for by using an existing search method, for example, the N-Gram search method. A phrase pattern candidate extracted as a result of search is stored in the phrase pattern candidate memory 143 of the memory 140.

The phrase pattern matching unit 128 performs a pattern matching process on the phrase stored in the bilingual phrase memory 144 and the phrase pattern candidate stored in the phrase pattern candidate memory 143 by using a method similar to that of the sentence pattern matching unit 125 to determine whether or not the phrase is a pattern defined by the phrase pattern candidate. A phrase that is determined to be a pattern defined by the pattern candidate is stored in the bilingual phrase memory 144, and is input again to the bilingual phrase extraction unit 126. Text data that is not determined to represent a pattern defined by the pattern candidate is output to the word alignment extraction unit 129. The above phrase and the text data are also registered in the bilingual phrase dictionary database 500 in association with each other.

The word alignment extraction unit 129 operates as a translated text determination unit that determines one sub-text (first sub-text) to be translated into the second language in accordance with the comparison results obtained by the sentence pattern matching unit 125, the phrase pattern matching unit 128, and any other suitable pattern matching unit and in accordance with position correspondence information. The word alignment extraction unit 129 also operates as a registration unit that registers the first sub-text and a second sub-text defined as a translated text of the first sub-text which has been determined by the translated text determination unit in a dictionary database in association with each other. The word alignment extraction unit 129 performs a word alignment process of determining that when each of phrases input from the bilingual phrase extraction unit 126 and the phrase pattern matching unit 128 is composed of one word, the words are corresponding translated words. The word alignment process may be executed by using an existing method, for example, the method disclosed in Japanese Unexamined Patent Application Publication No. 2010-027020. The extracted translated words are registered in the bilingual word dictionary database 600 in association with each other.

Next, the operation of the information processing apparatus 100 according to this exemplary embodiment will be described with reference to a flowchart. FIG. 14 is a flowchart illustrating the operation of the information processing apparatus 100 according to this exemplary embodiment.

First, the information processing apparatus 100 performs text processing, such as pattern matching, on a text stored in the bilingual example sentence dictionary database 200 (step S1401).

Then, the information processing apparatus 100 obtains phrases into which the text is divided in step S1401, and specifies a correspondence relationship between the phrases in the first text and the phrases in the second text by using processing such as pattern matching (step S1402).

The information processing apparatus 100 performs a translated text determination process and a registration process based on the result of phrase processing in step S1402 (step S1403). Then, the process ends.

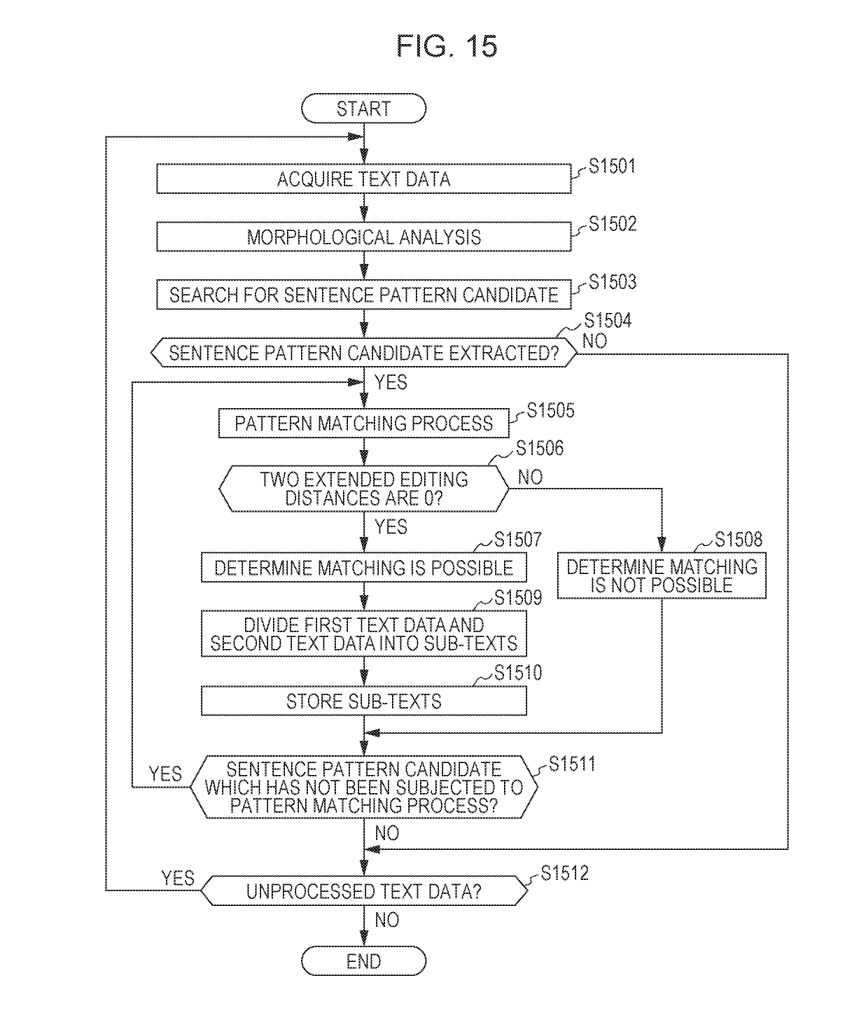

Next, the text processing in step S1401 in FIG. 14 will be described. FIG. 15 is a flowchart illustrating text processing performed by the information processing apparatus 100 according to this exemplary embodiment.

First, the text data acquisition unit 122 acquires first text data (text data 701) and second text data (text data 702) from the bilingual example sentence dictionary database 200 (step S1501). The morphological analysis unit 123 performs morphological analysis of the first text data and the second text data which have been acquired by the text data acquisition unit 122 in step S1501 (step S1502).

Then, the sentence pattern candidate search unit 124 searches for a sentence pattern candidate (bilingual sentence pattern) that can match the input first text data (step S1503). It is determined whether or not a sentence pattern candidate has been extracted in step S1503 (step S1504). If a sentence pattern candidate has been extracted, the process proceeds to step S1505. If no sentence pattern candidate has been extracted, the process proceeds to step S1512.

If it is determined in step S1504 that a sentence pattern candidate has been extracted in step S1503, the sentence pattern matching unit 125 performs a pattern matching process between the first text data and the second text data which have been subjected to morphological analysis in step S1502 and the first sentence pattern and the second sentence pattern in the sentence pattern candidate extracted in step S1503 to determine whether or the first text data and the second text data can match the first sentence pattern and the second sentence pattern, respectively (step S1505).

Determination is performed on the result of the processing of step S1505 (step S1506). If the extended editing distance between the first text data and the first sentence pattern and the extended editing distance between the second text data and the second sentence pattern are 0, it is determined that the bilingual sentence pattern can match the bilingual text data (step S1507). Then, the bilingual phrase extraction unit 126 further divides each of the first text data and the second text data into sub-texts (step S1509), and the obtained sub-texts are additionally stored in the bilingual phrase memory 144 (the sub-texts are not added if no redundant data exists) (step S1510). Then, the process proceeds to step S1511. If one of the extended editing distances is not 0, it is determined that the bilingual sentence pattern does not match the bilingual text data (step S1508). Then, the process proceeds to step S1511. In step S1511, it is determined whether or not the sentence pattern candidates extracted in step S1503 include any sentence pattern candidate that has not been subjected to pattern matching. If a sentence pattern candidate that has not been subjected to pattern matching is found, the process returns to step S1505 and a pattern matching process is performed on the sentence pattern candidate that has not been subjected to pattern matching. If a sentence pattern candidate that has not been subjected to pattern matching is not found, the process proceeds to step S1512. In step S1512, the text data acquisition unit 122 checks whether or not there is unprocessed text data. If there is unprocessed text data, the process returns to step S1501. If there is no unprocessed text data, the text processing ends.

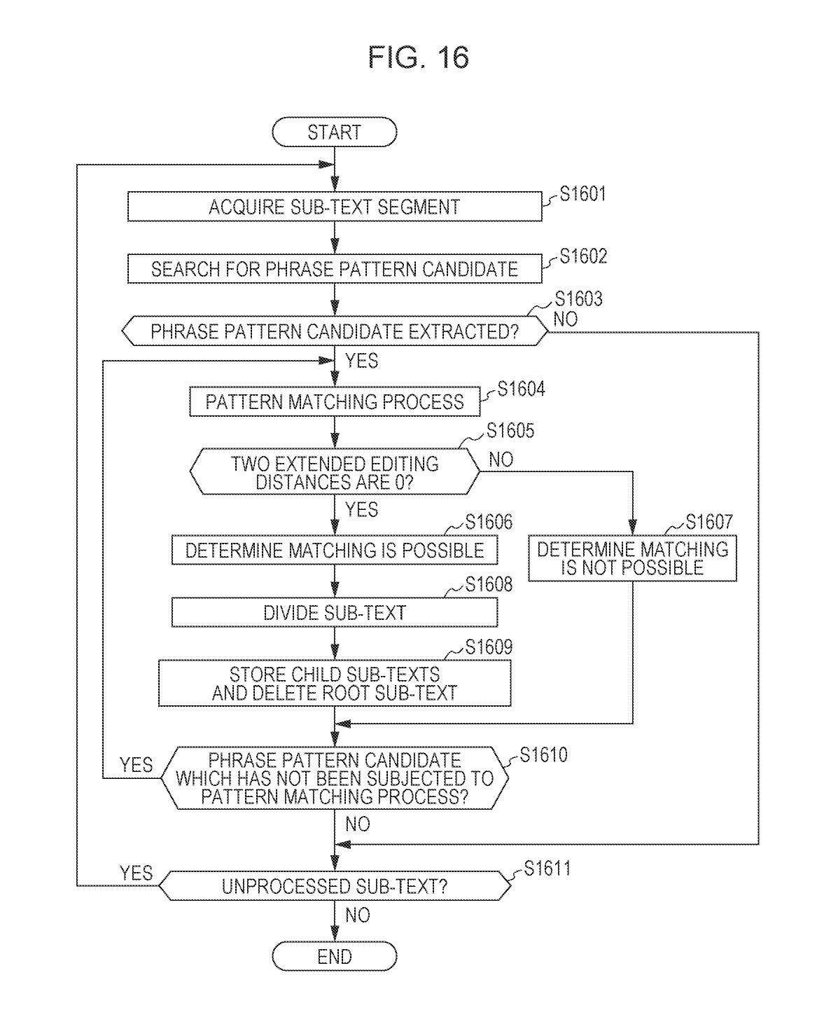

Next, the process of specifying a correspondence relationship between phrases in step S1402 in FIG. 14 will be described. FIG. 16 is a flowchart illustrating phrase processing of the information processing apparatus 100 according to this exemplary embodiment.

The phrase pattern candidate search unit 127 acquires a sub-text stored in the bilingual phrase memory 144 (step S1601), and searches phrase patterns stored in the bilingual phrase pattern dictionary database 400 for a phrase pattern (phrase pattern candidate) that can match the acquired sub-text (step S1602). It is determined whether or not a phrase pattern candidate has been extracted in step S1602 (step S1603). If a phrase pattern candidate has been extracted, the process proceeds to step S1604. If no phrase pattern candidate has been extracted, the process proceeds to step S1611.

If it is determined in step S1603 that a phrase pattern candidate has been extracted in step S1602, the phrase pattern matching unit 128 performs a pattern matching process between the sub-text and one of the phrase pattern candidates extracted in step S1602 (step S1604).

Determination is performed on the result of the processing of step S1604 (step S1605). If the two extended editing distances are 0, it is determined that the sub-text can match the pattern defined by the phrase pattern candidate (step S1606), and the bilingual phrase extraction unit 126 divides the sub-text (hereinafter, root sub-text) into child sub-texts (step S1608). The child sub-texts generated in step S1608 are additionally stored in the bilingual phrase memory 144 (the child sub-texts are not added if no redundant data exists), and the root sub-text is deleted from the bilingual phrase memory 144 (step S1609). Then, the process proceeds to step S1610. If one of the extended editing distances is not 0, it is determined that the sub-text can match the pattern defined by the phrase pattern candidate (step S1607). Then, the process proceeds to step S1610. In step S1610, it is determined whether or not there is any sentence pattern candidate that has not been subjected to pattern matching among the sentence pattern candidates extracted in step S1602. If there is a sentence pattern candidate that has not been subjected to pattern matching, the process proceeds to step S1604, and pattern matching of a sentence pattern candidate that has not been subjected to pattern matching is performed. If there is no sentence pattern candidate that has not been subjected to pattern matching, the process proceeds to step S1611. In step S1611, it is checked whether or not there is any unprocessed sub-text. If there is an unprocessed sub-text, the process proceeds to step S1601, whereas if there is no unprocessed sub-text, the phrase processing ends.

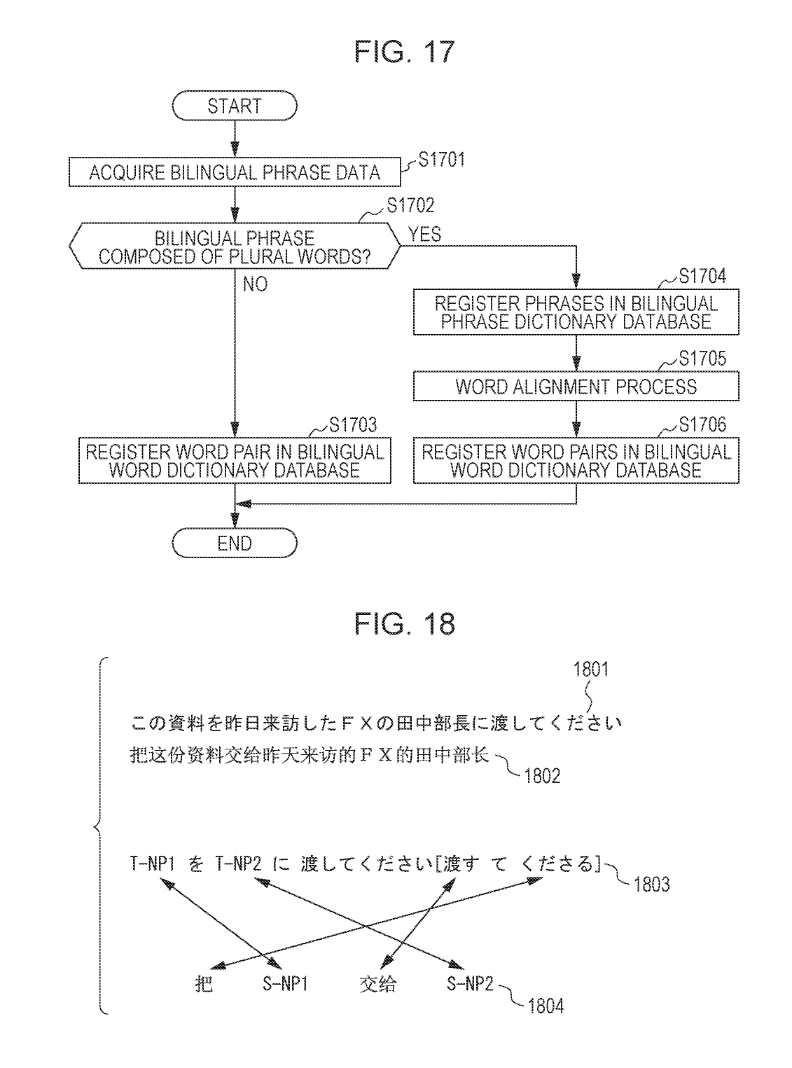

Next, the translated text determination process and registration process in step S1403 in FIG. 14 will be described. FIG. 17 is a flowchart illustrating a translated text determination process and a registration process, which are performed by the information processing apparatus 100 according to this exemplary embodiment.

The word alignment extraction unit 129 acquires bilingual phrase data to be stored in the bilingual phrase memory 144 (step S1701). Then, the word alignment extraction unit 129 determines whether or not each of the phrases in the bilingual phrase pair acquired in step S1701 is composed of plural words (step S1702). If at least one of the phrases in the bilingual phrase pair is composed of one word, the word pair is registered in the bilingual word dictionary database 600 (step S1703). Then, the translated text determination process and the registration process end. If each of the phrases in the bilingual phrase pair is composed of plural words, the word alignment extraction unit 129 registers the bilingual phrase pair in the bilingual phrase dictionary database 500 (step S1704), executes a word alignment process (step S1705), and registers bilingual word pairs obtained through the word alignment process in the bilingual word dictionary database 600 (step S1706). Accordingly, the translated text determination process and the registration process end.

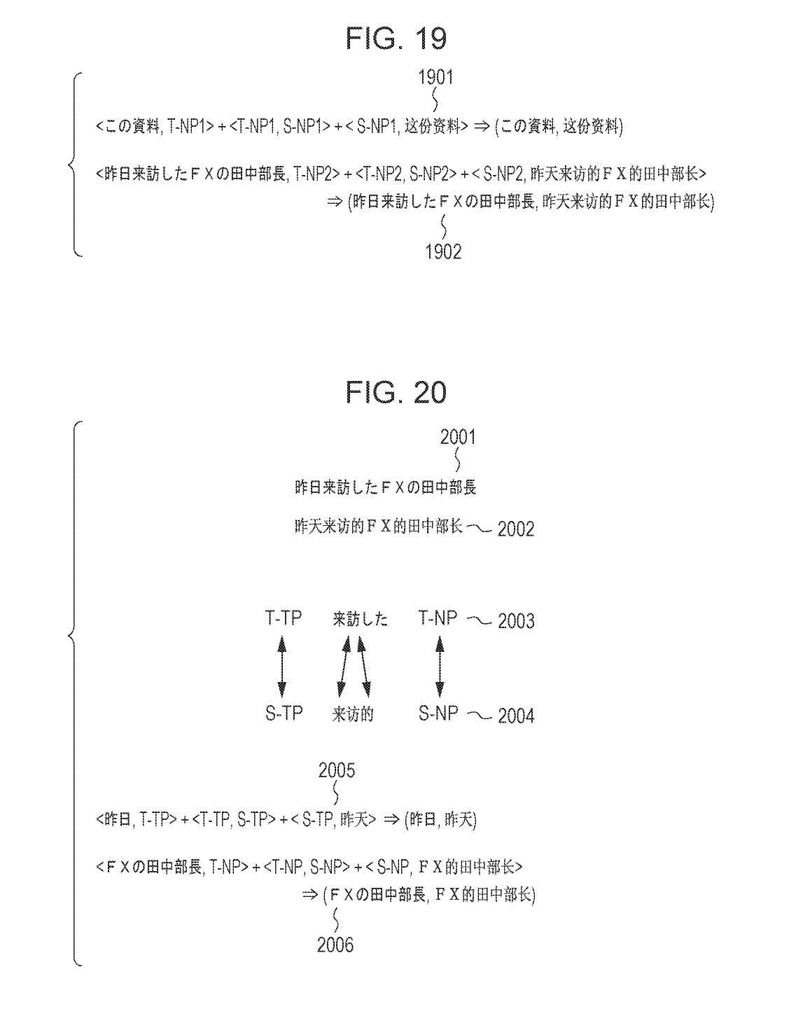

Next, the process performed by the information processing apparatus 100 according to this exemplary embodiment will be described using an example of specific data. FIGS. 18 to 21 illustrate an example of data to be processed by the information processing apparatus 100 according to this exemplary embodiment. First, text data 1801 and text data 1802 are stored in the bilingual example sentence dictionary database 200, and patterns 1803 and 1804 and information indicating the correspondence relationships indicated by arrows are stored in the bilingual sentence pattern dictionary database 300. The morphological analysis unit 123 performs morphological analysis of the text data 1801 and the text data 1802, and the sentence pattern candidate search unit 124 searches for a sentence pattern candidate. In addition, the sentence pattern matching unit 125 performs pattern matching. As a result, correspondence relationships 1901 and 1902 illustrated in FIG. 19 are obtained. In the correspondence relationships 1901 and 1902, <A, B> represents that A corresponds to B. Specifically, in the correspondence relationships 1901 and 1902, the first term in the left-hand side defines the relationship between the text data 1801 and the pattern 1803, the second term defines the relationship between the pattern 1803 and the pattern 1804, and the third term defines the relationship between the pattern 1804 and the text data 1802. As a result, the relationship between the text data 1801 and the text data 1802 defined in the right-hand side is obtained.

Then, pattern matching is performed on each of the phrases in which the relationships are obtained here. For example, an example of performing pattern matching on a phrase having the relationship indicated by the correspondence relationship 1902 in FIG. 19 is illustrated in FIG. 20. Specifically, phrases 2001 and 2002 are subjected to pattern matching with, for example, patterns 2003 and 2004, and correspondence relationships 2005 and 2006 are obtained, respectively.

There is no pattern that matches “ [symbol] (which is a Japanese phrase that means this material)” (and a corresponding phrase in Chinese) or that matches “FX [symbol] (which is a Japanese phrase that means Mr. Tanaka served as Manager of FX)” (and a corresponding phrase in Chinese), which have the correspondence relationships described above. Since each of these phrases is composed of plural words, the word alignment extraction unit 129 executes a word alignment process (see steps S1702 and S1705 in FIG. 17) to extract word pairs.

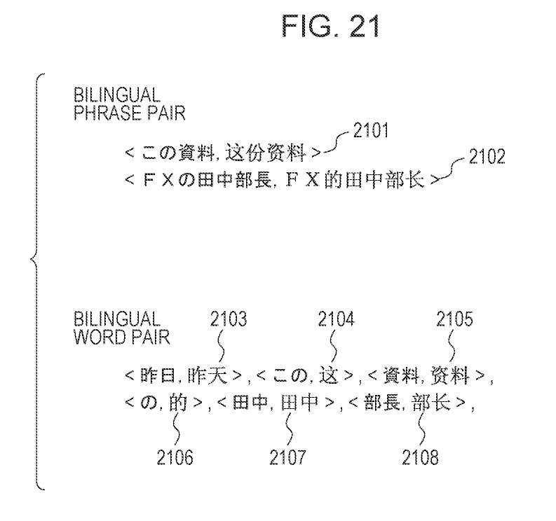

Consequently, as illustrated in FIG. 21, bilingual phrase pairs 2101 and 2102 and bilingual word pairs 2103, 2104, 2105, 2106, 2107, and 2108 are determined, and are registered in the bilingual word dictionary database 600.

With the above configuration, a translated text of a first sub-text that is part of a first text written in a first language is determined in accordance with the first text, a second text having the same content as the first text and written in a second language, and position correspondence information indicating a correspondence relationship between the position of at least one word, which is identified by first layout information indicating a layout of words in a given phrase when the phrase is written in the first language, and the position of a corresponding word, which is identified by second layout information indicating a layout of words in the given phrase when the phrase is written in the second language.

Therefore, for example, a bilingual word dictionary relating to a new field may be created using a bilingual example sentence dictionary database 200 relating to the field. Processing may be performed using a combination of an existing bilingual sentence pattern dictionary database 300 and bilingual phrase pattern dictionary database 400 of desired languages, thus allowing automatic creation of a bilingual word dictionary relating to the field.

While this exemplary embodiment provides the configuration of the information processing apparatus 100 in which a comparatively easily obtained or generated text (sentence) is used as data to be input, a phrase that is part of a text may also be used from the beginning. In this case, the configurations separately provided for handling texts and phrases may be integrated into a single configuration. In this case, the morphological analysis unit 123 and the bilingual phrase extraction unit 126 may be integrated into a single morphological analysis unit (which operates as a first sub-text generation unit and a second sub-text generation unit), the sentence pattern candidate search unit 124 and the phrase pattern candidate search unit 127 may be integrated into a single phrase pattern candidate search unit, and the sentence pattern matching unit 125 and the phrase pattern matching unit 128 may be integrated into a single phrase pattern matching unit.

The operation of the information processing apparatus 100 described above may be implemented by activating a program stored in the program memory 141 of the memory 140. The program may be provided via communication or may be stored in and provided through a computer-readable storage medium such as a compact disc read-only memory (CD-ROM).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a text acquisition unit that acquires a first text written in a first language and a second text written in a second language, the second text having the same content as the first text;
a position correspondence information acquisition unit that acquires, for each of phrases in a plurality of formats, position correspondence information indicating a correspondence relationship between a position of a given word in the phrase when the phrase is written in the first language and a position of a word corresponding to the given word in the phrase when the phrase is written in the second language;
a first sub-text generation unit that divides the first text into a plurality of first sub-texts;
a second sub-text generation unit that divides the second text into a plurality of second sub-texts;
a first comparison unit that compares, for each of the phrases in the plurality of formats, a layout of a plurality of words in the phrase when the phrase is written in the first language with a layout of the plurality of first sub-texts in the first text;
a second comparison unit that compares, for each of the phrases in the plurality of formats, a layout of a plurality of words in the phrase when the phrase is written in the second language and a layout of the plurality of second sub-texts in the second text; and
a translated text determination unit that determines a translated text of at least one of the plurality of first sub-texts, the translated text being one of the plurality of second sub-texts and being obtained by translating the at least one of the plurality of first sub-texts into the second language, in accordance with a comparison result obtained by the first comparison unit, a comparison result obtained by the second comparison unit, and the position correspondence information.

2. The information processing apparatus according to claim 1, further comprising:
a layout information acquisition unit that acquires, for each of the phrases in the plurality of formats, first layout information indicating a layout of a plurality of words in the phrase when the phrase is written in the first language and second layout information indicating a layout of a plurality of words in the phrase when the phrase is written in the second language,
wherein the translated text determination unit includes
a layout information determination unit that determines first layout information corresponding to the first text and second layout information corresponding to the second text in accordance with a comparison result obtained by the first comparison unit, a comparison result obtained by the second comparison unit, and the position correspondence information, and
wherein after the layout information determination unit determines the first layout information and the second layout information,
the first sub-text generation unit acquires a first sub-text among the plurality of first sub-texts as a first text, and further divides the first text into segments, and
the second sub-text generation unit acquires a second sub-text among the plurality of second sub-texts as a second text, and further divides the second text into segments.

3. The information processing apparatus according to claim 1, further comprising:
a registration unit that registers in a dictionary database in association with each other the at least one of the plurality of first sub-texts and the one of the plurality of second sub-texts determined by the translated text determination unit to be the translated text.

4. A computer readable medium storing a program causing a computer to execute a process, the process comprising:
acquiring a first text written in a first language and a second text written in a second language, the second text having the same content as the first text;
acquiring, for each of phrases in a plurality of formats, position correspondence information indicating a correspondence relationship between a position of a given word in the phrase when the phrase is written in the first language and a position of a word corresponding to the given word in the phrase when the phrase is written in the second language;
dividing the first text into a plurality of first sub-texts;
dividing the second text into a plurality of second sub-texts;
comparing, for each of the phrases in the plurality of formats, a layout of a plurality of words in the phrase when the phrase is written in the first language with a layout of the plurality of first sub-texts in the first text;
comparing, for each of the phrases in the plurality of formats, a layout of a plurality of words in the phrase when the phrase is written in the second language and a layout of the plurality of second sub-texts in the second text; and
determining a translated text of at least one of the plurality of first sub-texts, the translated text being one of the plurality of second sub-texts and being obtained by translating the at least one of the plurality of first sub-texts into the second language, in accordance with comparison results obtained by the comparing and the position correspondence information.

5. An information processing method comprising:
acquiring a first text written in a first language and a second text written in a second language, the second text having the same content as the first text;
acquiring, for each of phrases in a plurality of formats, position correspondence information indicating a correspondence relationship between a position of a given word in the phrase when the phrase is written in the first language and a position of a word corresponding to the given word in the phrase when the phrase is written in the second language;
dividing the first text into a plurality of first sub-texts;
dividing the second text into a plurality of second sub-texts;
comparing, for each of the phrases in the plurality of formats, a layout of a plurality of words in the phrase when the phrase is written in the first language with a layout of the plurality of first sub-texts in the first text;
comparing, for each of the phrases in the plurality of formats, a layout of a plurality of words in the phrase when the phrase is written in the second language and a layout of the plurality of second sub-texts in the second text; and
determining a translated text of at least one of the plurality of first sub-texts, the translated text being one of the plurality of second sub-texts and being obtained by translating the at least one of the plurality of first sub-texts into the second language, in accordance with comparison results obtained by the comparing and the position correspondence information.
